(19) United States
(12) Patent Application Publication
(10) Pub. No.: US 2013/0027019 A1
(43) Pub. Date: Jan. 31, 2013

(54) Power supply with means for increasing a voltage

(71) Applicants: Wolfgang PAUL, Warstein-Belecke (DE); Peter WALLMEIER, Lippstadt (DE)

(72) Inventors: Wolfgang PAUL, Warstein-Belecke (DE); Peter WALLMEIER, Lippstadt (DE)

(73) Assignee: AEG POWER SOLUTIONS B.V., Zwanenburg (NL)

(21) Appl. No.: 13/364,071

(22) Filed: Feb. 1, 2012

(30) Foreign Application Priority Data
Jul. 29, 2011 (EP) 11176001.3

(51) Int. Cl. H01F 30/12

(52) U.S. Cl. 323/361

(57) ABSTRACT

The invention relates to a power supply arrangement with a first transformer (T1), with at least two secondary-side taps for a secondary-side phase conductor potential and with a tap for a secondary-side neutral conductor potential, wherein in standard operation of the first transformer a rated voltage drops between a first of the taps for the secondary-side phase conductor potential and the tap for the secondary-side neutral conductor potential, and with two power controllers (V1, V2) connecting the taps for the secondary-side phase conductor potential with a phase conductor terminal of an output of the power supply arrangement, wherein the circuit arrangement has on the secondary side of the first transformer (T1) a means (T2) for increasing the voltage above the rated voltage.

### BACKGROUND OF THE INVENTION

(1) Field of the Invention

The present invention relates to a power supply arrangement with a first transformer having at least two secondary-side taps for a secondary-side phase conductor potential and a tap for secondary-side neutral conductor potential, wherein in rated operation of the first transformer a rated voltage drops between a first of the taps for the secondary-side phase conductor potential and the tap for secondary-side neutral conductor potential, and with two power controllers for connecting the taps for the secondary-side phase conductor potential with a phase conductor terminal of an output of the power supply arrangement.

(2) Description of Related Art

Power supply arrangements of this type are known from a number of patents and published patent applications of the applicant or from legal predecessors of the applicant. Such power supply arrangements are also described, for example, in the textbook “Thyrorised Power Controllers” by G. K. Dubey, S. R. Doradla, A. Joshi and R. M. K. Sinha, ISBN 0-85226-190-X, published in the year 2009.

The power controllers of this type of power supply arrangement are typically controlled so as to produce a voltage sequence control. These power supply arrangements are frequently used with reactors for producing polysilicon by chemical vapor deposition (CVD) according to the Siemens process. These applications of the power supply arrangements have become known from patent applications of the applicant.

Supply arrangement arrangements with voltage sequence control can advantageously provide voltages in a high voltage range of, for example, 0 to 2500 V with a large power factor and a large power range compared to other power supply devices.

In a process for producing polysilicon according to the Siemens process, a current, which is initially driven by a high-voltage, flows through silicon seed rods (also referred to as thin silicon rods or hair pins) having initially a high electrical resistance. After a certain heat-up of the thin silicon rods, the resistance suddenly decreases, which is commonly referred to as ignition of the thin silicon rods. The voltage can be reduced after ignition.

The electric current flowing through the thin silicon rods heats the thin silicon rods to a temperature required for the vapor deposition according to the Siemens process. Silicon is deposited on the thin silicon rods by vapor deposition, thus increasing their diameter, with the thin silicon rods developing into silicon rods. The electrical resistance for the current flowing through the silicon rods decreases with increasing diameter of the silicon rods. The voltage applied to the silicon rods is thus further reduced during the vapor deposition process. In a vapor deposition process, the highest voltage must therefore be provided by the power supply arrangement before ignition of the thin silicon rods, and the lowest voltage at the end of the process.

Different initial voltages are necessary or advantageous depending on the operation of the process and depending on the reactor. It has been customary to this date to design the power supply arrangements so that the secondary rated voltage provided by the first transformer corresponds to the maximum required voltage. This requires, among others, individually managed transformers and power controllers matched to the rated voltage. Both requirements make the manufacture of power supply arrangements complex and expensive.

This is a starting point for the present invention.

### BRIEF SUMMARY OF THE INVENTION

The present invention addresses the problem of improving a power supply arrangement of the aforedescribed type so as to enable standardization of the power supply arrangements or at least of important components of the power supply arrangements.

This problem is solved by the invention in that the circuit arrangement has on the secondary side of the first transformer a means for increasing the voltage above the rated voltage.

By providing the means for increasing the voltage at the output of the power supply arrangement above the rated voltage of the first transformer or above the voltage tapped at the first transformer with the means for increasing the voltage, a first transformer can then also be used when the desired rated voltage of the power supply arrangement exceeds the rated voltage of the first transformer. A first transformer can therefore also be used for those power supply arrangements which have to this date required a different transformer with a higher rated voltage.

Preferably, the means for increasing the voltage is a connectable second transformer. The second transformer can be connected with switches or power controllers. The power controllers connected to the taps of the first transformer for the secondary-side phase conductor potential may also be used for connecting the second transformer.

In a particularly advantageous embodiment, the second transformer may be an autotransformer.

A center tap of the second transformer may be connected to the first tap of the first transformer, i.e., the tap for the highest secondary-side phase conductor potential with respect to the secondary-side neutral conductor potential of the first transformer. The connection can be made by interconnecting a power controller and/or a switch which can be used to connect the autotransformer as a means for increasing the voltage.

A tap at a first end of a transformer coil of the autotransformer may be connected to a tap of the first transformer, preferably to the tap of the first transformer with the second-highest secondary-side phase conductor potential. The connection may be made by interconnecting a power controller and/or a switch which can be used to connect the autotransformer as a means for increasing the voltage.

A tap at a second end of the transformer coil of the autotransformer may be connected with the first terminal of the output. The connection may be made by interconnecting a power controller and/or a switch which can be used to connect the autotransformer as a means for increasing the voltage.

The power controllers used in a power supply arrangement according to the invention may be implemented as thyristor power controllers. The employed switches may be switches constructed from rectifier valves, in particular thyristors, GTOs, IGBT or others. Advantageously, the switches are bidirectional.

### BRIEF DESCRIPTION OF THE SEVERAL VIEWS OF THE DRAWING(S)

Other features and advantages of the present invention will be described in more detail with reference to the following description of two exemplary embodiments, wherein:

FIG. 1 shows a circuit diagram of a first exemplary embodiment, and

FIG. 2 shows a circuit diagram of a second exemplary embodiment.

### DETAILED DESCRIPTION OF THE INVENTION

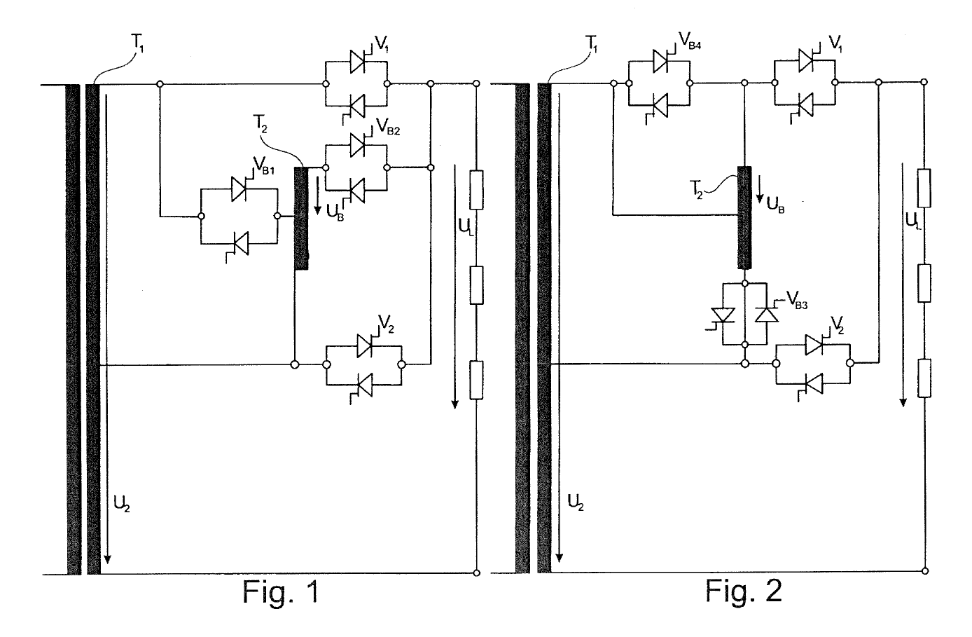

The circuit diagrams of circuit arrangement according to the invention illustrated in FIGS. 1 and 2 include a first transformer T1, two power controllers V1, V2 connected to secondary-side taps of a first transformer T1, a two-stage voltage sequence control (not illustrated in detail) used to control the two power controllers V1 and V2, and a means T2 for increasing the voltage which can be additionally connected by way of bidirectional switches or power controllers.

The first transformer T1 and the two power controllers V1, V2 are connected with each other in a conventional manner. The first transformer T1 has three tabs on the secondary side, wherein a secondary-side phase conductor potential is provided at two taps, whereas a secondary-side neutral conductor potential is provided at the third tab. The two taps at the phase conductor potential are connected by way of the power controllers V1, V2 with a first terminal representing the phase conductor terminal of an output of the circuit arrangements according to the invention. The tap for the neutral conductor potential is connected with a second terminal representing a neutral conductor terminal of the output. Three resistors are connected to the output as a load, with the resistors implemented, for example, as silicon rods or thin silicon rods arranged in a reactor for producing polysilicon by chemical vapor deposition according to the Siemens process.

The power controllers V1, V2 can be controlled by the conventional voltage sequence control for adjusting any desired voltage between the 0 V and the rated voltage of the first transformer T1.

For providing a higher voltage than the rated voltage of the first transformer T1 at the output of the power supply arrangement, the means T2 for increasing the voltage above the rated voltage present at the transformer a first of the taps for secondary-side phase conductor potential during standard operation are provided, wherein the means are formed in both exemplary embodiments by a second transformer. This second transformer is implemented as an autotransformer T2.

The two exemplary embodiments illustrated in FIGS. 1 and 2 differ in the way the autotransformer T2 is incorporated in or can be connected to the rest of the circuit arrangement.

In the first exemplary embodiment, the center tap of the transformer coil of the autotransformer T2 is connected by way of a bidirectional switch VB1 composed of two antiparallel-connected thyristors to the first tap of the first transformer T1, i.e., the tap having the highest phase conductor potential with respect to the secondary-side neutral conductor potential. Conversely, a tap at a first end of the transformer coil of the autotransformer T2 is connected with the tap of the first transformer having the second-highest phase conductor potential with respect to the secondary-side neutral conductor potential.

When the switch VB1 and the power controller VB2 are switched on and the power controllers V1 and V2 are switched off, a voltage UL drops across the output which corresponds to the sum of the secondary voltage of the first transformer T1 and a voltage UB that drops between the second end of the transformer coil of the autotransformer T2 and the center tap of the transformer coil of the autotransformer T2. The magnitude of this voltage can be adjusted by a phase angle control of the power controller VB2.

Conversely, when the switch VB1 and the power controller VB2 are switched off, the output voltage UL can be adjusted via the power controllers V1, V2 in a conventional manner by the voltage sequence control.

In a variant of the first exemplary embodiment, the thyristors VB1 can be used as power controllers and controlled with a phase angle control. The second end of the transformer coil of the autotransformer T2 can in this case be connected directly with the phase conductor terminal of the output. When the voltage is to be increased, the autotransformerT2 can be switched in and the output voltage can be adjusted with the power controller VB1. The thyristors VB2 can then be used as bidirectional switches or replaced by a wire.

In the second exemplary embodiment, the center tap of the transformer coil of the autotransformer T2 is directly connected with the first tap of the secondary winding of the first transformer T1, i.e., the tap having the highest phase conductor potential with respect to the secondary-side neutral conductor potential. A tap at a first end of the transformer coil of the autotransformer T2 is in the second exemplary embodiment connected by way of a bidirectional switch V3 composed of two antiparallel-connected thyristors with the tap of the first transformer T1 having the second-highest phase conductor potential with respect to the secondary-side neutral conductor potential. The tap at the second end of the transformer coil of the autotransformer T2 is in the second exemplary embodiment connected with the first tap of the secondary winding of the first transformer T1, i.e., the tap with the highest phase conductor potential, by way of a bidirectional switch VB4 composed of two antiparallel-connected thyristors. When the switch VB4 and the power controller V2 are switched off and the power controller V1 and the switch VB3 are switched on, a voltage UL drops across the output of the circuit arrangement according to the second exemplary embodiment, with the voltage UL corresponding to the sum of the secondary voltage of the second transformer T1 and the voltage between the second tap also transformer coil of the autotransformer T2 and the center tap of the transformer coil of the autotransformer T2. The magnitude of this voltage can be adjusted with the power controller V1.

Conversely, when the switch VB4 is switched on and the switch VB3 is switched off, the circuit arrangement according to the second exemplary embodiment can be used like a conventional circuit arrangement with voltage sequence control.

Other suitable components, in particular power semiconductor components, such as IGBT, can be used as components for the power controllers or bidirectional switches. Circuit breakers or relays may also be used as bidirectional switches.

1. A power supply arrangement comprising
a first transformer (T1) having at least two secondary-side taps for a secondary-side phase conductor potential and with a tap for a secondary-side neutral conductor potential,
wherein in standard operation of the first transformer a rated voltage drops between a first of the taps for the secondary-side phase conductor potential and the tap for secondary-side neutral conductor potential, and with two power controllers (V1, V2) connecting the taps for the secondary-side phase conductor potential with a phase conductor terminal of an output of the power supply arrangement, and
wherein the circuit arrangement on the secondary side of the first transformer (T1) comprises a means (T2) for increasing the voltage above the rated voltage.

2. The power supply arrangement according to claim 1, wherein the means (T2) for increasing the voltage is a second transformer that can be additionally connected.

3. The power supply arrangement according to claim 2, wherein the second transformer is an autotransformer (T2).

4. The power supply arrangement according to claim 3, wherein a center tap of the second transformer (T2) is connected to the first tap of the first transformer, optionally by interconnection of a power controller (VB1, VB2) or a switch (VB1, VB2, VB3, VB4).

5. The power supply arrangement according to claim 3, wherein a tap at a first end of a transformer coil of the autotransformer is connected to a tap of the first transformer.

6. The power supply arrangement according to claim 3, wherein a tap at a first end of a transformer coil of the autotransformer is connected by interconnection of a power controller or a switch to a tap of the first transformer having the second-highest secondary-side phase conductor potential.

7. The power supply arrangement according to claim 3, wherein a tap at a second end of the transformer coil of the autotransformer is connected to the first terminal of the output.

8. The power supply arrangement according to claim 3, wherein a tap at a second end of the transformer coil of the autotransformer is connected by interconnection of a power controller or a switch to the first terminal of the output.
